(19) United States
(12) Patent Application Publication
(10) Pub. No.: US 2011/0132333 A1
(43) Pub. Date: Jun. 9, 2011

(54) INTERNAL COMBUSTION ENGINE WITH WORKING, PISTON AND CONTROL PISTON

(76) Inventors: Luiz Carlos Leite Proenca, Sorocaba (BR); Claudemir De Abreu E Silva, Sorocaba (BR); Frederico Do Amaral Colella, Sorocaba (BR)

(21) Appl. No.: 12/999,060

(22) PCT Filed: Jun. 16, 2009
(86) PCT No.: PCT/BR2009/000162

§ 371 Date: Feb. 14, 2011

(30) Foreign Application Priority Data
Jun. 17, 2008 (BR) PI 0805766-4
Oct. 20, 2008 (BR) PI 0804463-5

(51) Int. Cl. F02B 75/28

(52) U.S. Cl. 123/51 R

(57) ABSTRACT

The invention relates to an internal combustion engine comprising two opposed pistons sharing the same cylinder (FIG. 1), being a working piston (1) and a control piston (2). The working piston (1) is connected to the crankshaft (3) by means of a connecting rod (4) and a wristspin (5) all of these four components according to the Prior Art. The control piston (2) in other hand, is actuated by a non-sinusoid actuation system (6) which moves the control piston (2) so that the combustion chamber (7) is positioned in a more favorable point to generate torque by the working piston (1). The intake port (8) and exhaust port (9) are operated by means of valves (10) and their respective valve train mechanism (11) according to the Prior/Art, being positioned on the cylinder wall (11) instead of the classic construction of the Prior Art, on the engine head.

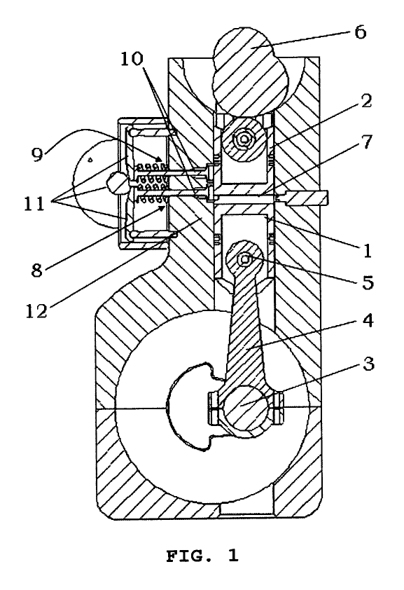

The present invention refers to an internal combustion engine having two opposed pistons sharing the same cylinder (FIG. 1), being one working piston 1, and one control piston 2. The working piston 1 is connected to the crankshaft 3 by means of a connecting rod 4 and a wristpin 5, all of these four components according to the Prior Art. The control piston 2, in other hand, is actuated by a non-sinusoid actuation system 6, which moves the control piston 2 so that the combustion chamber 7 is positioned in a more favorable point to generate torque by the working piston 1. The intake port 8 and exhaust port 9 are operated by means of valves 10 and their respective valve train mechanism 11 (single or double overhead camshaft, or electro-magnetic actuation), according to the Prior Art, being positioned on the cylinder wall 12, instead of the classic construction of the Prior Art, on the engine head.

The non-sinusoid actuation system 6 can be disposed on two ways: mechanically connected to the crankshaft 3 or synchronized to the rotation of the crankshaft 3 through an electric/electronic system.

### a) Mechanically Connected to the Crankshaft 3:

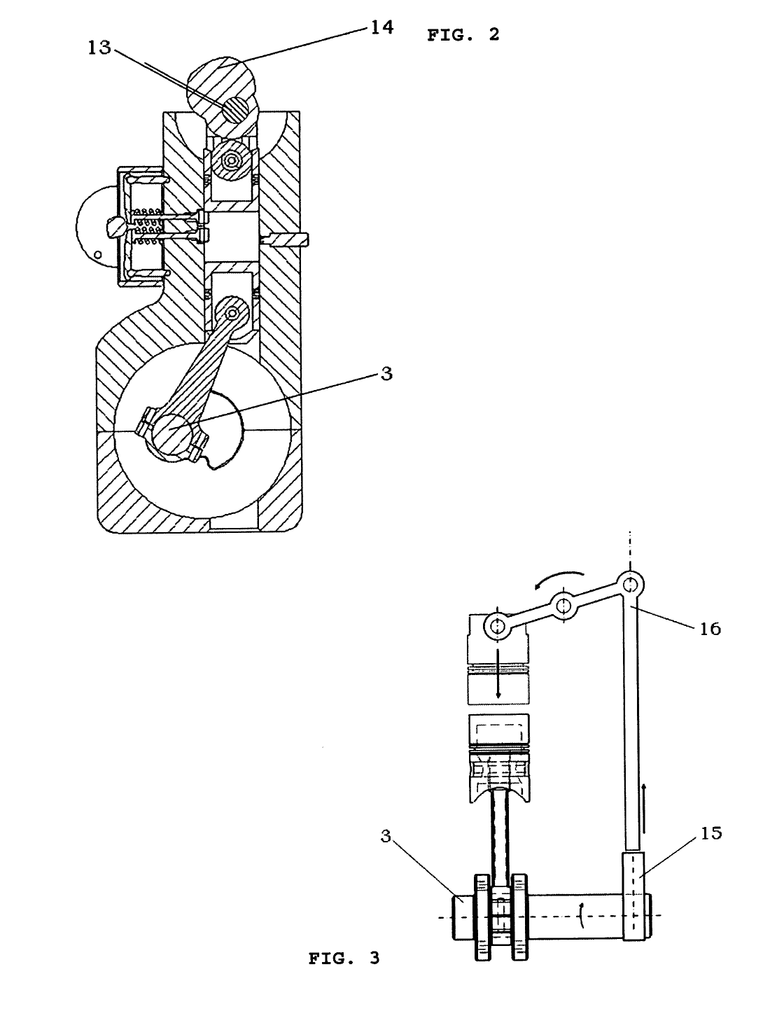

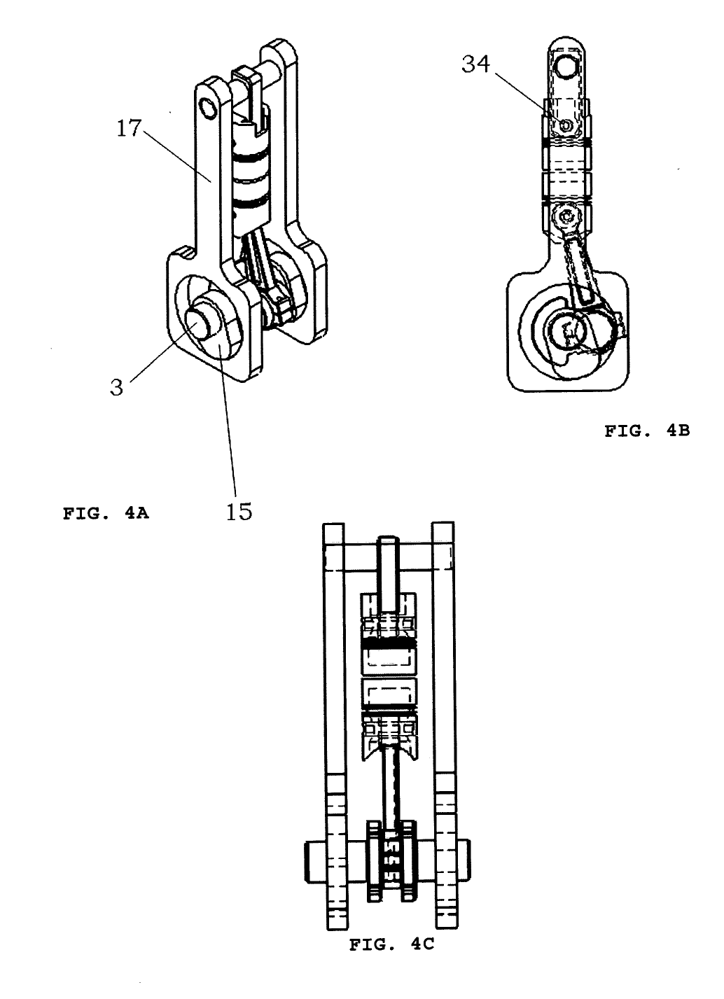

This configuration can be realized transferring the rotary movement of the crankshaft 3 to a secondary shaft 13, which contains the non-sinusoid actuation element 14 (FIG. 2), through toothed belt drive, chain drive or gears, according to the Prior Art, or converting the rotary movement of the crankshaft 3 into linear movement by means of a cam 15 located on the crankshaft 3, driving an actuation system of the control piston 2, whose configuration may be done in form of a rod 16 or geometry that has the same effect (FIG. 3), or a bar with an eye 17 for the control piston actuation, being a single or double arrangement (FIG. 4).

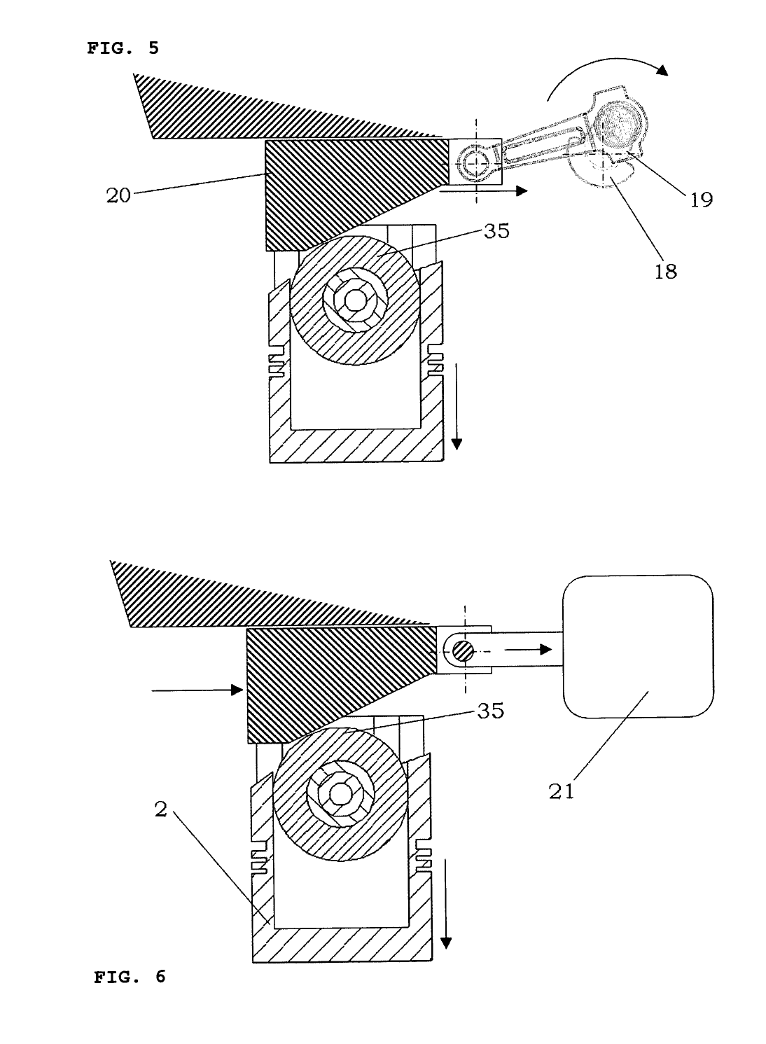

It is also possible to apply a non-sinusoid actuation system based on inclined plane, as shown on FIG. 5, where the rotary movement of the crankshaft 3 is transferred to a secondary crankshaft 18, which works with a connecting rod 19, driving cyclically an inclined plane element 20 against the control piston 2.

In all of these cases it is necessary to pay attention on the pros and cons of each configuration may bring in terms of moving parts and effects on the cyclic movement of the control piston 2.

b) Synchronized to the Crankshaft 3 Rotation through an Electric/Electronic System:

The system is actuated by means of a pneumatic, hydraulic or electromagnetic module 21, according to the Prior Art, which transfers the generated rectilinear or rotary movement to a secondary shaft that drives the non-sinusoid actuation system, as already before mentioned, or transferring the rectilinear movement to a device with inclined plane (FIG. 6), in all of these configurations a sensor is present (speed sensor, position sensor, accelerometer, noise or vibration sensor) to determine the crankshaft 3 position, allowing the command unit to define the ideal time and speed to actuate the control piston 2.

All the non-sinusoid elements can be so projected to permit modular assembly, allowing modifying the compression ratio and the control piston 2 movement by replacing only one single sub-assembly of the non-sinusoid system, concentrating higher production volumes on the remaining items of the engine.

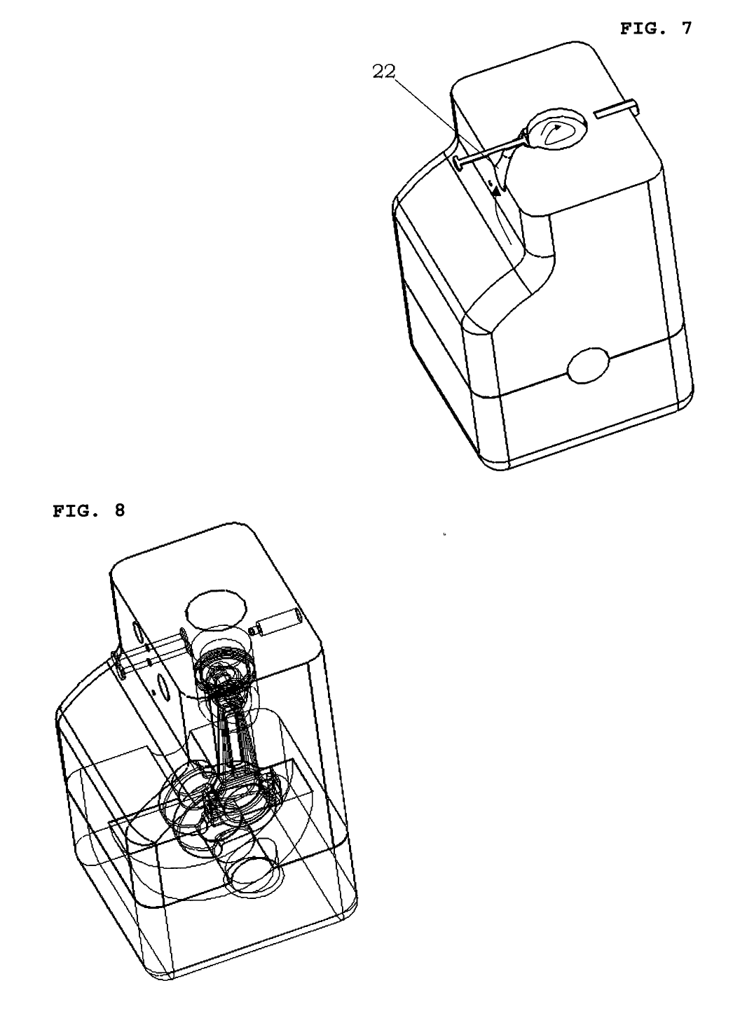

The arrangement of the intake valve(s) 22 (FIG. 7) on the cylinder wall permits the gases for the combustion entering like a swirl into the cylinder, facilitating the air/fuel mixture homogenization.

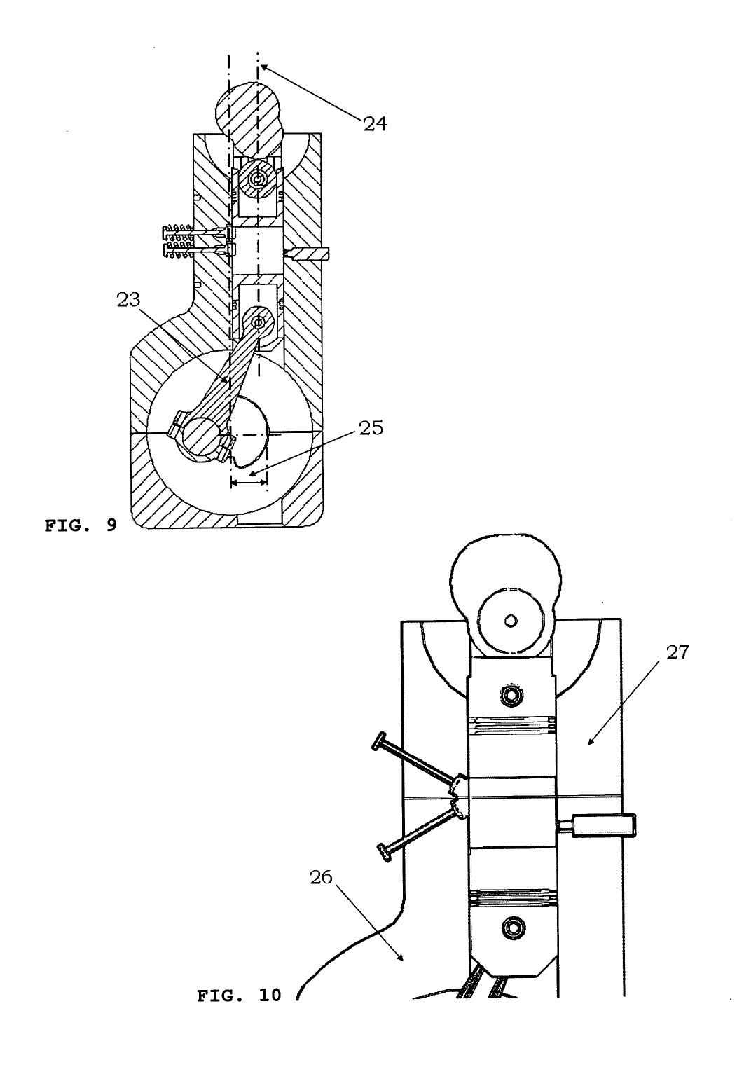

The present invention permits to apply spark plugs, fuel injectors and glow plugs on the cylinder wall, enabling the construction of Otto and Diesel cycles variants, according to the Prior Art. FIG. 8 shows the arrangement of an Otto cycle engine.

The present invention permits the working piston cylinder centerline to be coincident with the crankshaft centerline, corresponding to the classic configuration of the Prior Art, or shifted (FIG. 9). The most favorable arrangement of the cylinder centerline 23 in reference to the crankshaft centerline 24 is the distance equals to the lever arm 25 formed by the connecting point of the connecting rod big-end eye, because it converts in maximum torque the exerted force by the combustion gases pressure on the working piston top surface, and additionally exerts lower radial forces acting against the crankshaft.

It also reduces the side counterforce exerted by the connecting rod on the working piston wristpin and thus the side counterforce of the working piston against the cylinder wall.

However, this optimized construction requires the displacement of the control piston to be approximately the half of the working piston displacement, demanding more attention on the non-sinusoid system project.

The present invention comprises two possible arrangements for the position of the compression and oil control rings of the working piston 1 and control piston 2:
i) Next to the exposed surface of both pistons to the combustion chamber 7, according to the Prior Art.

However, this configuration requires a special system of guidance to avoid the rotation of the intake and exhaust valves over their longitudinal axles, in addition also special manufacturing process to the valves, injectors, spark and glow plugs, because the rings pass cyclically on their assembly positions, and it is not allowed to have collisions neither clearances that could expose lubricant oil to the combustion process, therefore increasing the lubricant oil consumption and consequently the ratio of pollutants on the exhaust gases.
ii) far from the exposed surface of both piston to the combustion chamber 7, so that the rings do not pass over the assembly position of the aggregated elements on the cylinder wall (valves, injectors, plugs and similar parts) during the pistons movement. In this way the aggregated elements can be embedded on the cylinder wall, avoiding collisions with the pistons. This configuration of the compression and oil control rings do not permit more deposition of the lubricant oil compared to what it occurs on the Prior Art, so the ratio of pollutants from the lubricant on the exhaust gases are kept in the actual level of the Prior Art.

On the example given on FIG. 1, the block that contains the working cylinder of the pistons is a one-piece design, what requires special machining methods, mainly the valve seat on the interior of the cylinder.

Alternatively, a two-piece design can be chosen, as shown on FIG. 10, being a working piston block 26, and a control piston block 27. The valves are arranged inclined to the junction surface of both blocks, what permits more access to the valve assembly area, allowing the usage of conventional machining processes.

The valves can be assembled entirely on the control piston block, or entirely on the working piston block, or in both blocks, as shown in FIG. 10, on the same side of the blocks or opposed, and the same concept of assembly flexibility is valid for the remaining components located on the cylinder wall (injectors, spark plugs, glow plugs etc).

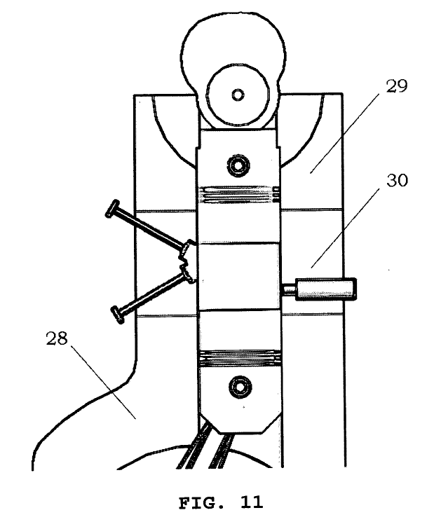

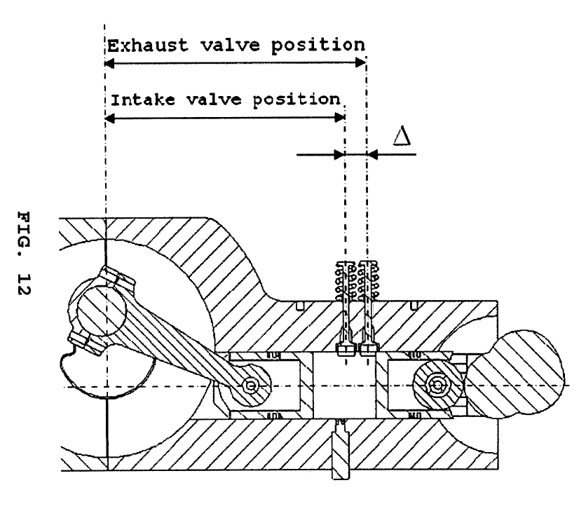

Alternatively it is also possible to apply three blocks as shown on FIG. 11, being one working piston block 28, one control piston block 29, and one intermediate block for the aggregates assembly, being also valid the same flexibility for the arrangement of valves and aggregates mentioned on the solution of two blocks shown on FIG. 10.

The longitudinal positioning of the valves referred to the working and control piston movement must permit the intake and exhaust gases are not obstructed by the pistons during their passage over the valves, what can result in different positioning between the intake and exhaust valves, as shown on FIG. 12.

Thereto the beginning and the duration of the valves opening must respect the dynamics of the two pistons, in order to assure that the majority of the pos-combustion gases are expelled on the same proportion that it is achieved by the Prior Art, and also the gases for the combustion may have enough time to form the necessary mixture for the combustion phase, on the same proportion that is achieved by the Prior Art. A graphic example is shown on FIG. 13, being the solid line representing the working piston displacement, the dashed line representing the control piston displacement, the dotted-dashed line representing the intake valve opening/closing, and the double-dotted-dashed line representing the exhaust valve opening/closing.

On the example shown on FIG. 13, the actuation cycle of the control piston by the non-sinusoid system has the same order of the working piston, i.e., for each movement of the working piston from the top dead center (TDC) to the bottom dead center (BDC), there is an attack movement of the control piston.

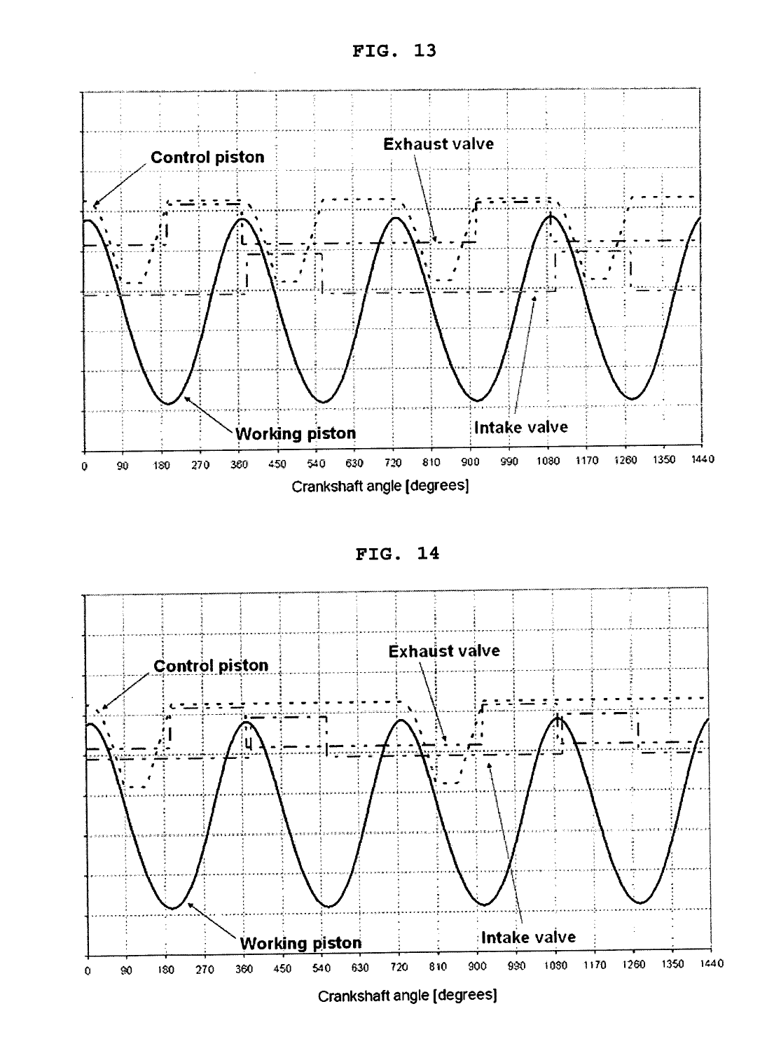

Alternatively, it can be applied a control piston movement with a reduction on the order by the half, what would lead to a cycle with an actuation only during the adjustment phase of the combustion chamber position just before the combustion, eliminating the control piston attack during the intake stroke, as shown on FIG. 14.

This permits also that the position of the intake valve(s) can be closer to the exhaust valve(s), also shown on FIG. 14.

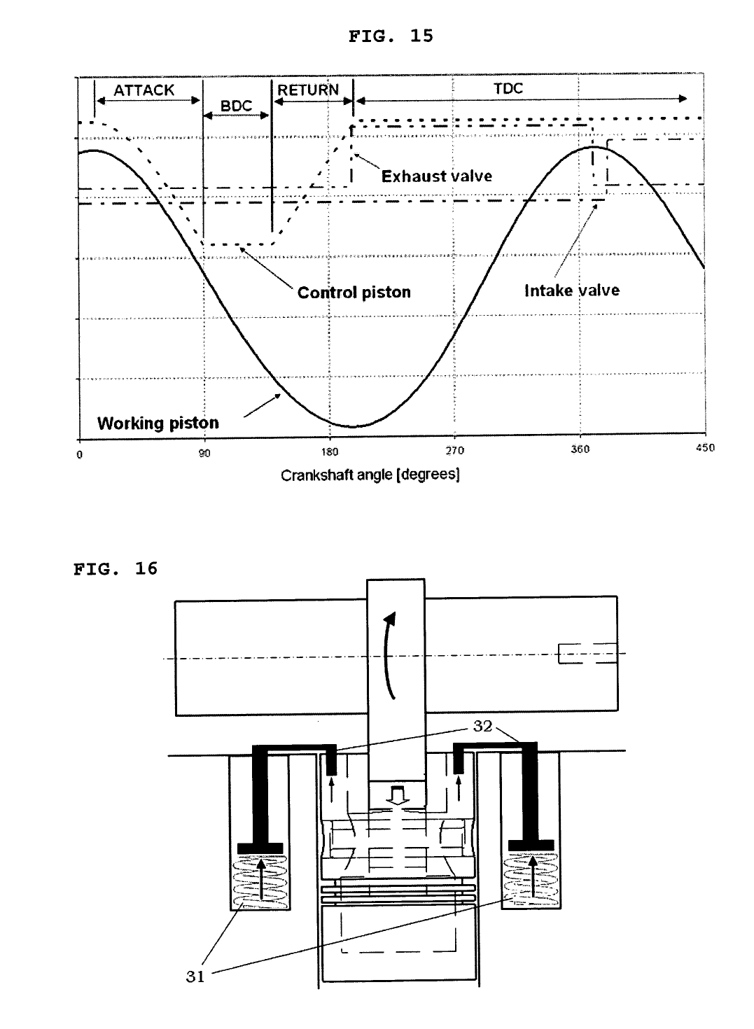

The non-sinusoid actuation system project must permit to obtain the following phases of the control piston (FIG. 15):
a) Attack, being its main function to adjust the combustion chamber to a more favorable position for torque generation;
b) Staying on the bottom dead center (BDC), responsible to form a fixed wall for the combustion chamber, so the internal pressure increase is converted on mechanical work by the working piston;
c) Return to the top dead center (TDC), whose velocity must respect the beginning and duration of the intake and exhaust valves opening, but must occur before or simultaneously the working piston reaches its top dead center (TDC) on the same stroke;
d) Staying on the top dead center (TDC), whose duration will depend on the strokes before mentioned on the items a, b and c, and also on the control piston actuation order (on every downwards stroke of the working piston or only just before the combustion stroke).

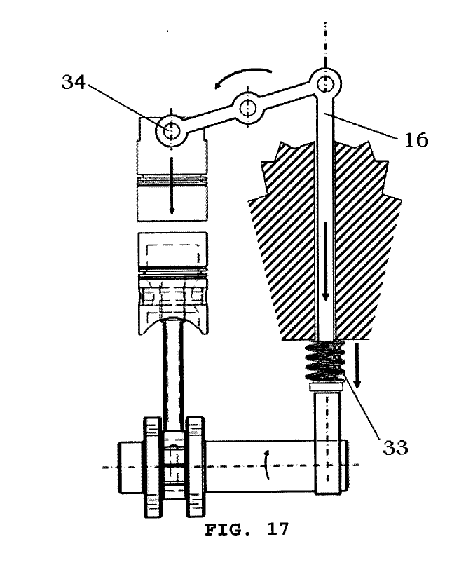

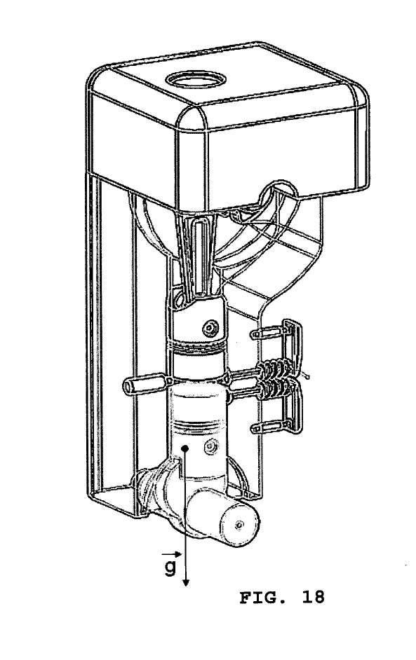

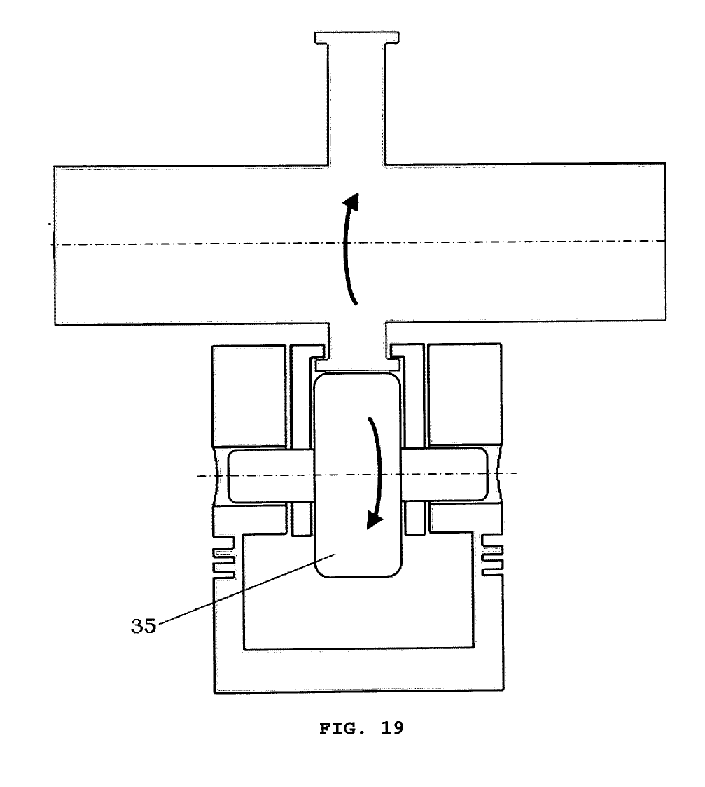

The return system of the control piston depends on the applied non-sinusoid actuation system arrangement, but can be also performed by the correct determination of the position and opening time of the valves, assuring that, in every returning stroke, the internal pressure is sufficient to return the control piston on the compression and exhaust strokes, as shown on the example given on FIG. 13, or by one of the options described bellow, or even by a combination thereof:
i) Returning spring(s) 31 and rod(s) 32 as shown in FIG. 16, assembled between the cylinder head or the block and control piston;
ii) Returning spring(s) 33 on the actuation rod 16 as shown on FIG. 17;
iii) Inverted arrangement of the internal combustion engine, the control piston return performed by the action of the gravity, as shown on FIG. 18;
v) System applying claws between the cam and the control piston, in a single or double arrangement, as shown on FIG. 19.

The joint between the control piston and the non-sinusoid actuation system depends on the arrangement of the last one, by means of a pin 34 as shown on FIGS. 4 and 17, or bearing 35, as shown on FIGS. 5, 6 and 19.

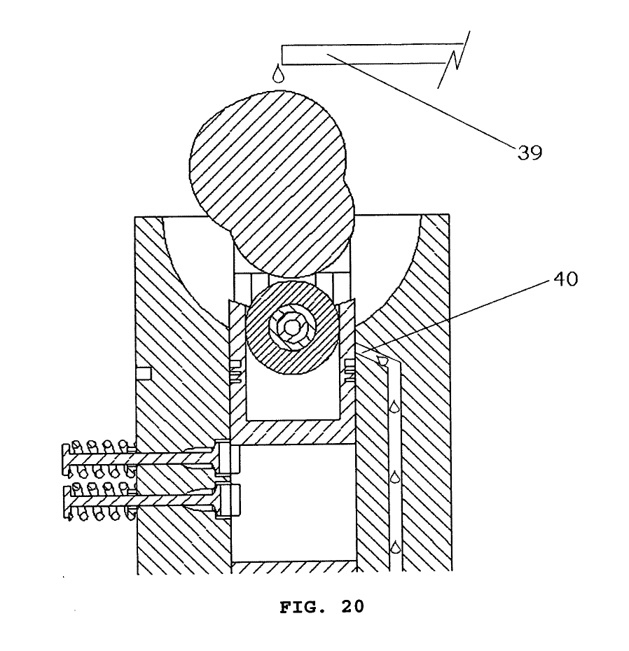

The control piston joint 35 may be cylindrical roller bearing, tapered roller bearing, ball roller bearing, needle roller bearing, all of them according to the Prior Art, in a single or double arrangement, or even comprised by an inner ring 36, locked to the wristpin 37, and an outer ring 38, moveable, which follows the non-sinusoid actuation system element, as shown on FIG. 20.

The lubrication of the control piston actuation system elements and the return of the lubricant to the oil pan depend on the chosen non-sinusoid actuation system, being possible by immersion, dropping, aspersion or forced-feed lubrication, all of them according to the Prior Art.

As an example, FIG. 21 shows a dropping lubrication system by a pipe 39, where the lubricant return to the oil pan is done through a channel 40 on the block, whose beginning is located just above the control piston rings on its top dead center (TDC), to avoid the lubricant accumulation just above the rings.

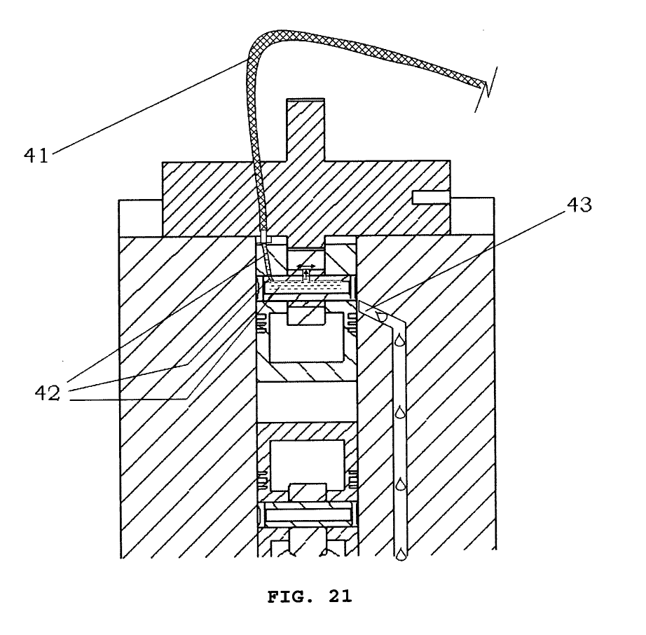

Another lubrication example is given on FIG. 22, where the lubricant reaches the bearing or the outer ring 38 through a flexible pipe 41 and channels 42 on the control piston, on the wristpin and on the inner ring. The lubricant return to the oil pan is done also through a channel 43 on the block, whose beginning is located just above the control piston rings on its top dead center (TDC), to avoid the lubricant accumulation just above the rings

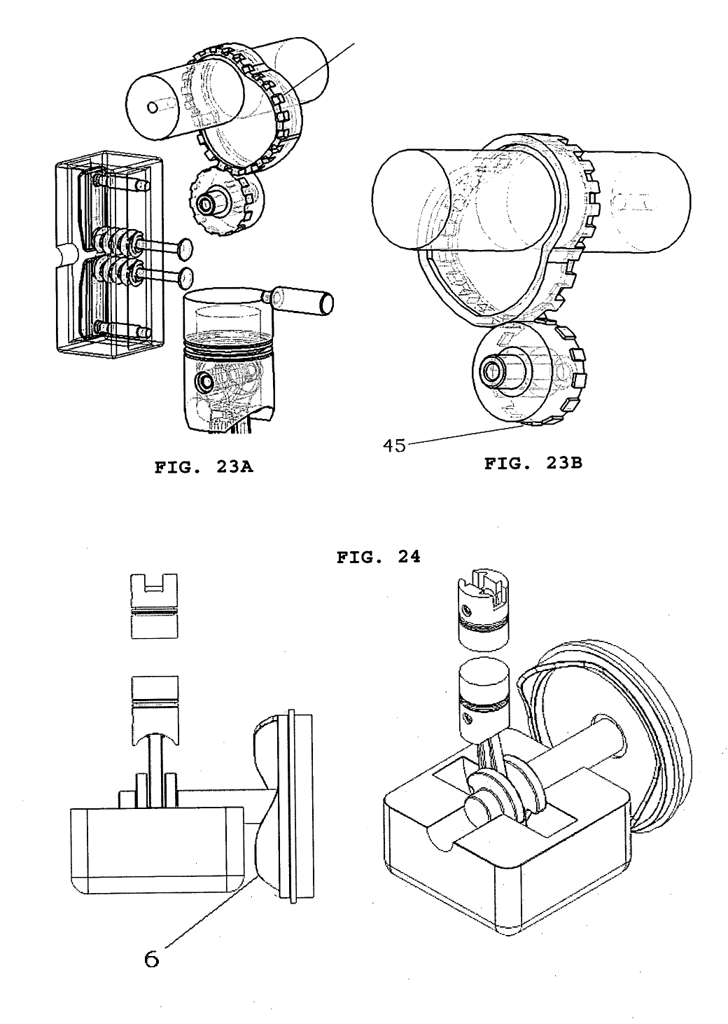

By applying a bearing 35 or an arrangement of inner ring 36 and outer ring 38, the contact of the outer ring to the non-sinusoid actuation element can be optimized adding a mating design (44 and 45) according to the Prior Art, or a geometry that produces analogous effect, ensuring a continuous rotary movement of the outer ring 38 referred to the inner ring, as shown on FIG. 23. This construction requires special attention to the mating design project for the cam contour, due to its non-circular geometry.

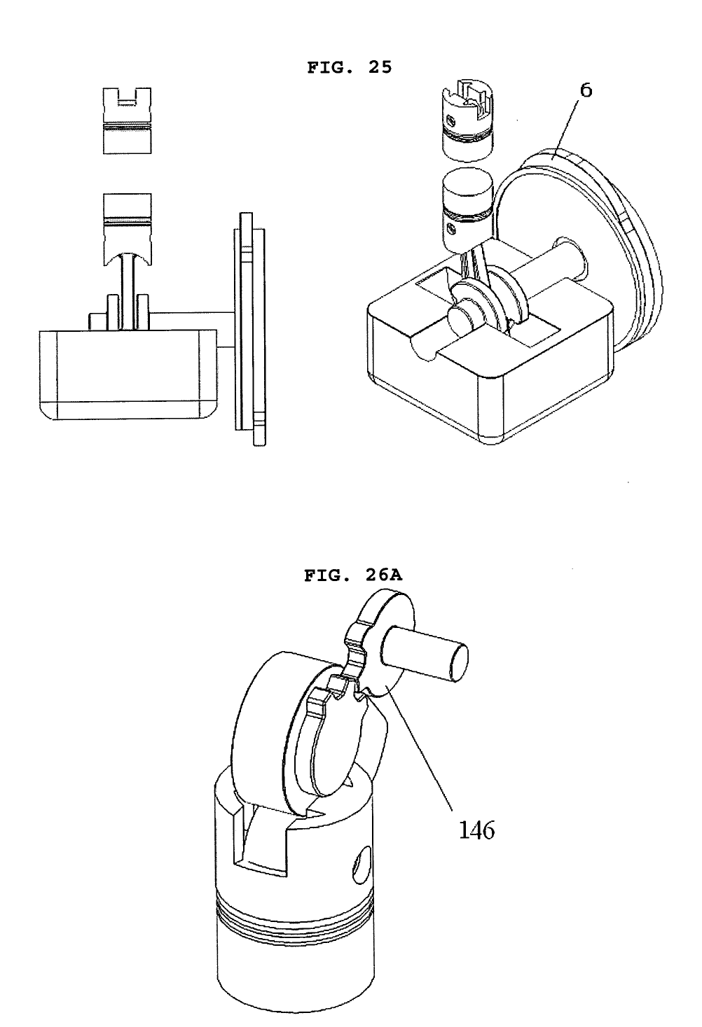

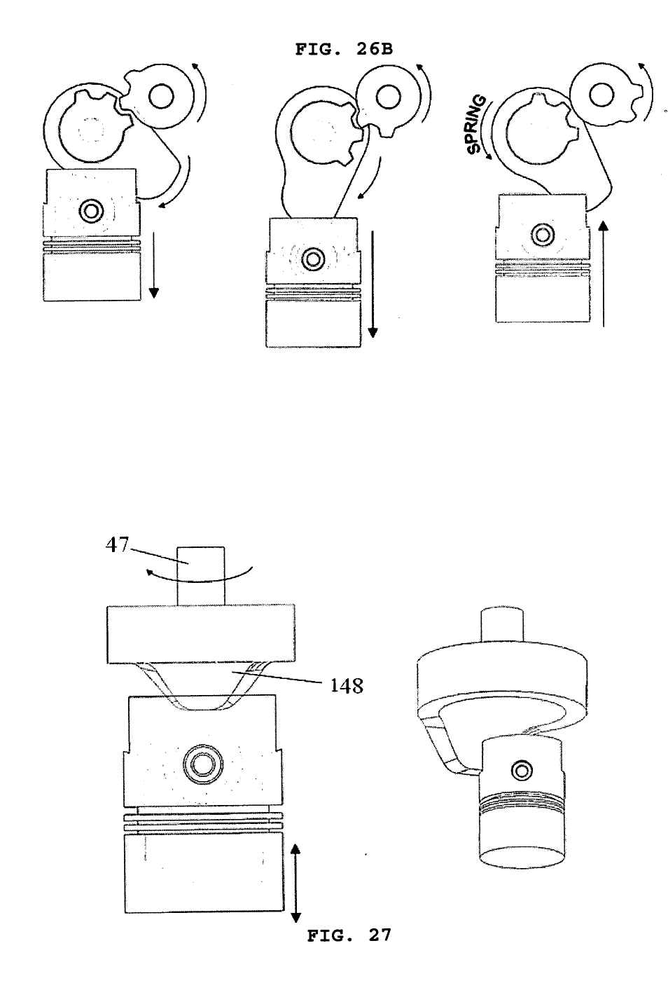

The before mentioned non-sinusoid actuation system 6 can be also arranged as follows:
a cam or a plurality of cams can be located on the engine flywheel, installed or machined directly on it, axially (FIG. 24) or radially (FIG. 25), considering that for multiple cylinders it may be necessary to apply a corresponding number of cams. For transmitting the movement of the cam contact to the control piston 2, a rod system may be applied, generating the non-sinusoid movement on the control piston 2.
a special designed gear 46, which intermittingly actuates a cam and its shaft (FIGS. 26a and 26b), comprising a pneumatic system or springs to return to the non-actuated position. The actuation system is connected to the working piston crankshaft movement by means of toothed belt drive, chain drive or gears.
a shaft 47 that rotates perpendicularly in reference to the crankshaft rotation (FIG. 27) and is mechanically connected to it. A cam 48 is assembled on the shaft 47, actuating at least one control piston.
a cam 49 (FIG. 28) actuated by the module 21 in order to perform the non-sinusoid actuation.

The construction shown on FIG. 1 details a 4-stroke internal combustion engine configuration; however, applying the Prior Art, it is possible to replace the valves by ports in such a position to permit the 2-stroke cycle.

Keeping the anterior configuration, with valves, it is possible to perform 6-stroke cycle, being intake, compression, combustion, exhaustion, pure or additive water injection through an exclusive injector, and finally vapor exhaustion.

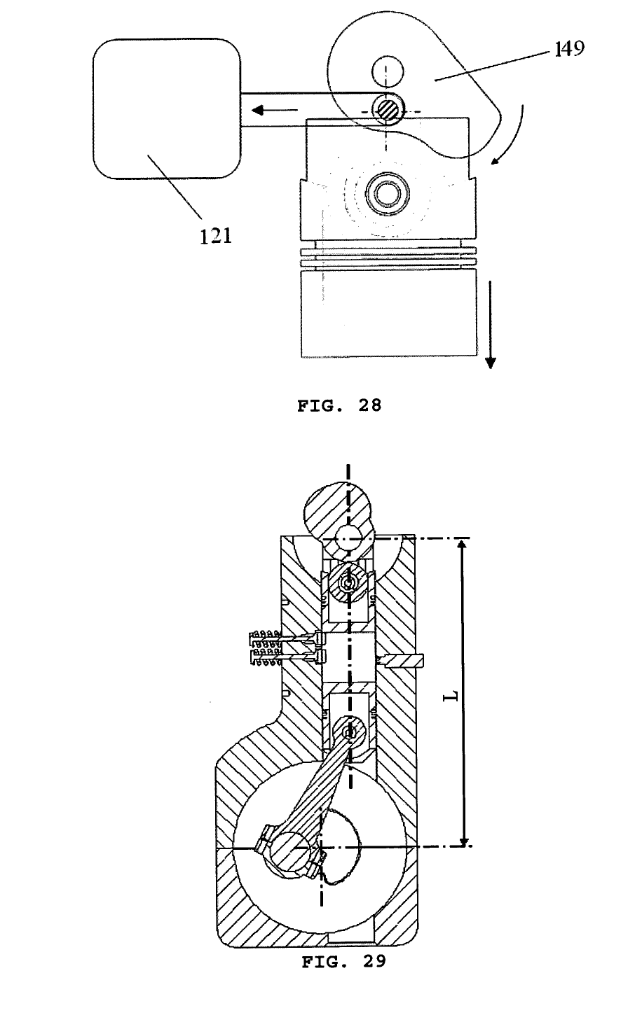

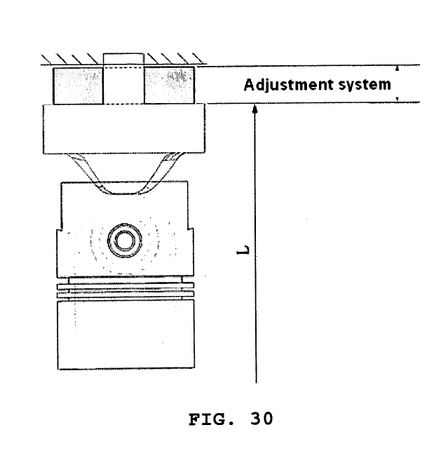

In order to obtain higher efficiency on the hereto proposed engine, it is possible to introduce a system for adjusting the non-sinusoid actuation element referred to the crankshaft centerline, permitting to vary the compression ratio (FIGS. 29 and 30).

The before mentioned non-sinusoid elements may be projected to allow the control piston 2 to move during the exhaust phase minimizing the distance between the control piston 2 and the working piston 1, performing a more complete exhaustion of the gases generated during the combustion process.

In the same concept, the movement of the control piston 2 during the attack phase can be adjusted in order to continue the compression even after the combustion process commencement, aiming gain in combustion chamber inner pressure and therefore gain on system efficiency. Alternatively, it is possible to decide for the movement of the control piston 2 during the attack phase compressing the combustible mixture until a controlled auto-ignition starts, in a more homogeneous process, looking for efficiency increase and/or exhaust gas pollutants reduction.

The proposed internal combustion engine construction permits the application of more than one spark plugs, contribution for leaner and more efficient mixture combustion. Similarly, it is possible to apply more than one injector, permitting also more flexibility on the fuel injection stratification, or, additionally, applying more than one kind of fuel on the engine work, on the same stroke or not.

Subject to the adopted configuration, the cylinder wall can receive an additional valve to control the cylinder internal pressure when the engine works on engine brake regime (coast), increasing the braking efficiency on this condition. The generated pressurized gases of this process can be kept on a reservoir, being reintroduced later on the engine chamber to generate torque on the crankshaft 3.

To increase the engine efficiency, it is possible to apply additional pressurization of the air or combustible mixture into the combustion chamber, like compressor or turbo.

The same invention concept hereto presented can be applied using pressurized gas introduction through valves or ports on the cylinder wall, in order to increase the internal pressure on the chamber formed by the cylinder wall and the surfaces of the working and control pistons, generating torque on the crankshaft 3, being the pressurized gas deriving from process independent of engine operation.

### REFERENCE LIST

1. Working piston

2. Control piston

6. Non-sinusoid actuation system

7. Combustion chamber

12. Cylinder wall

13. Secondary shaft

14. Non-sinusoid actuation element

15. Cam

16. Rod

17. Bar with eye

20. Piece with inclined plane

21. Actuation module

23. Cylinder centerline

24. Crankshaft centerline

26/28. Working piston block

27/29. Control piston block

30. Intermediate block

31/33. Return spring(s)

38. Moveable outer ring

39. Lubrication pipe

41. Flexible lubrication pipe

44/45. Mating design between cam and outer ring

46. Special intermittent gear

47. Perpendicular shaft

48. Optional cam

49. Optional cam

1. INTERNAL COMBUSTION ENGINE WITH SPARK PLUG FOR THE COMBUSTION PROCESS COMMENCEMENT, with one or more cylinders, characterized by comprising:
a working piston (1) and a control piston (2) on the same cylinder; and
a non-sinusoid actuation system (6) of the control piston (2); and
the cylinder centerline (23) coincident to the 10 crankshaft centerline (24).

2-33. (canceled)
